(19) United States
(12) Patent Application Publication
(10) Pub. No.: US 2026/0029516 A1
(43) Pub. Date: Jan. 29, 2026

(54) OPTICAL DISTANCE MEASURING SENSOR

(71) Applicant: OMRON Corporation, Kyoto-shi (JP)

(72) Inventors: Yoshiki Tani, Kyoto-shi (JP); Shintaro Ando, Kyoto-shi (JP); Ryosuke Tsuzuki, Kyoto-shi (JP)

(21) Appl. No.: 19/255,704

(22) Filed: Jun. 30, 2025

(30) Foreign Application Priority Data
Jul. 26, 2024 (JP) 2024-120761

(51) Int. Cl. G01S 7/484; G01K 1/02; G01S 7/481; G01S 7/4865; G01S 17/10

(52) U.S. Cl. CPC G01S 7/484; G01K 1/026; G01S 7/4814; G01S 7/4865; G01S 17/10

(57) ABSTRACT

An optical distance measuring sensor includes a charge accumulation unit for generating a pulse current to be supplied to a light-emitting element; a setting unit that sets a target sensitivity; a pulse current controller that generates the pulse current in synchronization with a repetitive signal, pulse-drives the light-emitting element, and adjusts the pulse current based on the target sensitivity; a light-receiving element that receives the reflected light; a nonvolatile memory having characteristic data of the individual light-receiving element stored therein; a light-receiving element controller that adjusts a multiplication factor of the light-receiving element based on a temperature measured by a temperature sensor, the characteristic data, and the target sensitivity; and a calculation unit that calculates a time from when light is emitted to an object to when reflected light is received based on an output signal repeatedly obtained from the light-receiving element in which the multiplication factor has been adjusted.

This application claims the benefit of priority to Japanese Patent Application Number 2024-120761 filed on Jul. 26, 2024. The entire contents of the above-identified application are hereby incorporated by reference.

### TECHNICAL FIELD

The present disclosure relates to an optical distance measuring sensor.

### BACKGROUND

There is a photoelectric sensor that detects a workpiece by measuring a propagation time of light (for example, JP 2015-75453 A). In the photoelectric sensor of JP 2015-75453 A, detection light is repeatedly generated by a light-emitting element. A light-receiving element receives reflected light of the detection light and generates a light-receiving signal indicating a light receiving amount. The light-receiving signal is binarized and input to a delay line in which a large number of delay circuits for delaying a logic signal of one bit for a fixed time are connected in series. A branch point is provided between the delay circuits, and an output of each delay circuit is input to a large number of storage elements as binarized light-receiving signals after distribution. Thus, waveform data indicating temporal changes in the binarized light-receiving signal are generated in the large number of storage elements. Two or more waveform data are integrated by matching light-emitting timing of the light-emitting element, and the presence of a workpiece is determined based on the integrated waveform data.

### BRIEF SUMMARY

In the photoelectric sensor of JP 2015-75453 A, the presence of the workpiece is determined based on the integrated waveform data, but when a reflectance of the workpiece is low, a sensitivity is insufficient, and it is difficult to stably detect the workpiece.

In addition, when the photoelectric sensor is used as a sensor for factory automation (FA), the photoelectric sensor is required to operate stably even at a wider environmental temperature than general electric equipment. In addition, a light-receiving element having an amplification function may be used in order to improve the sensitivity, but such a light-receiving element has poor temperature characteristics when an amplification factor is large. Thus, in a case of stabilizing the sensitivity in a wide temperature range, the amplification factor is suppressed in use.

Further, the photoelectric sensor may be used not only in a case of detecting a workpiece having a low reflectance but also in a case of detecting a workpiece having a high reflectance. In such a case, since detection becomes difficult when the sensitivity is set too high, a function is required that can flexibly adjust the sensitivity in accordance with the properties of a detection object.

Thus, the present disclosure provides an optical distance measuring sensor that has a wide dynamic range and can be stably used even when the environmental temperature changes.

An optical distance measuring sensor according to an aspect of the present disclosure is an optical distance measuring sensor for estimating a distance to an object by measuring a time from when light is emitted to the object to when reflected light is received, and the sensor includes: a charge accumulation unit configured to accumulate charge for generating a pulse current to be supplied to a light-emitting element; a setting unit configured to set a target sensitivity of the optical distance measuring sensor; a pulse current controller configured to generate the pulse current in synchronization with a repetitive signal, and to pulse-drive the light-emitting element, the pulse current controller being configured to adjust the pulse current based on the target sensitivity; a light-receiving element configured to receive the reflected light; a first temperature sensor; a nonvolatile memory having characteristic data of the individual light-receiving element stored therein; a light-receiving element controller configured to adjust a multiplication factor of the light-receiving element based on a temperature measured by the first temperature sensor, the characteristic data, and the target sensitivity; and a calculation unit configured to calculate the time based on an output signal repeatedly obtained from the light-receiving element in which the multiplication factor has been adjusted.

As described above, with the configuration in which charge is accumulated in the charge accumulation unit as the energy source for generating the pulse current, it is possible to generate a pulse current having a high intensity based on the accumulated energy. Further, with the configuration in which the pulse current is generated in synchronization with a repetitive signal and the light-emitting element is pulse-driven, a time width of a projected light pulse can be narrowed and peak power can be increased while maintaining average power, so that the sensitivity can be enhanced. Furthermore, with the configuration in which the pulse current is adjusted based on the target sensitivity, not only projected light pulse having a high intensity can be emitted to the object, but also projected light pulse having a low intensity can be emitted to the object. On the light receiving side, with the configuration of adjusting the multiplication factor of the light-receiving element based on the temperature measured by the first temperature sensor, the characteristic data of the individual light-receiving element, and the target sensitivity, it is possible to perform control optimized for the characteristics of the light-receiving element and the environmental temperature, and thus, any individual can be operated at a high multiplication factor with suppressed fluctuation and achieve a stable high sensitivity. Further, for example, by adjusting a reverse bias of the light-receiving element, the light-receiving element can be operated even at a low multiplication factor with the suppressed fluctuation. Thus, it is possible to provide an optical distance measuring sensor that has a wide dynamic range and can be stably used even when the environmental temperature changes.

In the above aspect, the pulse current controller may adjust the pulse current by adjusting a charge amount accumulated by the charge accumulation unit based on the target sensitivity.

For example, in a case where the light-emitting element is irradiated with projected light pulse having a high intensity, a high current supply capability is required for a power supply of the pulse current. According to this aspect, since energy can be accumulated in advance in the charge accumulation unit, which is a passive element, and the pulse current having the high intensity can be generated based on the accumulated energy, it is possible to cause the light-emitting element to emit a projected light pulse having the high intensity with a simple circuit. Further, since the intensity of the pulse current can be adjusted by adjusting the charge amount accumulated in advance in the charge accumulation unit, the intensity of the projected light pulse can be easily adjusted.

In the above aspect, the pulse current controller may adjust the charge amount by controlling a voltage applied to the charge accumulation unit.

According to this aspect, since the charge amount proportional to the voltage applied by the control of the pulse current controller is accumulated in the charge accumulation unit, the adjustment of the charge amount can be simplified, and thus the adjustment of the intensity of the projected light pulse can be further simplified.

In the above aspect, the optical distance measuring sensor may further include a second temperature sensor, and a heater configured to maintain an operable temperature of the light-emitting element based on a temperature measured by the second temperature sensor.

According to this aspect, even at an ambient temperature that is not suitable for use of the light-emitting element, heat can be supplied to the light-emitting element by the heater, and the temperature of the light-emitting element can be set to a temperature suitable for use, so that the temperature range in which the optical distance measuring sensor can be used can be expanded.

In the above aspect, the heater, the first temperature sensor, the light-emitting element, and the light-receiving element may be mounted on the same substrate.

According to this aspect, since heat can be easily transferred through the substrate, both the light-emitting element and the light-receiving element can be favorably heated by causing the heater to generate heat. Further, the temperatures of both the light-emitting element and the light-receiving element can be satisfactorily measured by the first temperature sensor. That is, since the heating and the temperature measurement of the light-emitting element and the light-receiving element can be performed by one heater and one temperature sensor, for example, as compared with a configuration including two heaters that respectively heat the light-emitting element and the light-receiving element and two temperature sensors, the circuit scale can be reduced and the manufacturing cost can be reduced.

In the above aspect, the first temperature sensor and the second temperature sensor may be combined.

As compared with a configuration including two separate temperature sensors, according to this aspect, by combing the first temperature sensor for adjusting the multiplication factor of the light-receiving element and the second temperature sensor for maintaining the operable temperature of the light-emitting element, it is possible to reduce a circuit scale and a manufacturing cost.

In the above aspect, the characteristic data may include a breakdown voltage of the light-receiving element, a temperature coefficient of the breakdown voltage, and a temperature at the time of obtaining the breakdown voltage.

As described above, with the configuration in which the breakdown voltage, the temperature coefficient of the breakdown voltage, and the temperature at the time of obtaining the breakdown voltage, which are useful for adjusting the multiplication factor with suppressed fluctuation, are included in the characteristic data, the multiplication factor at the temperature can be easily and appropriately adjusted by the temperature and the characteristic data.

In the above aspect, the light-emitting element may be a laser diode.

According to this aspect, since the object can be irradiated with light having high intensity and good directivity, the sensitivity can be effectively enhanced.

Thus, according to the present disclosure, it is possible to provide an optical distance measuring sensor that has a wide dynamic range and can be stably used even when an environmental temperature changes.

### BRIEF DESCRIPTION OF THE DRAWINGS

FIG. 1 is a block diagram illustrating a configuration of an optical distance measuring sensor 101 according to a first embodiment.

FIG. 2 is a block diagram illustrating a configuration of a light projecting unit 40 in the optical distance measuring sensor 101 according to the first embodiment.

FIG. 3 is a block diagram illustrating a configuration of a light-receiving unit 50 in the optical distance measuring sensor 101 according to the first embodiment.

FIG. 4 is a perspective view of the optical distance measuring sensor 101 according to the first embodiment.

FIG. 5 is a side view of the optical distance measuring sensor 101 according to the first embodiment.

FIG. 6 is a plan view of a sensing substrate 12 according to the first embodiment as viewed from an object side.

FIG. 7 is a plan view of the sensing substrate 12 according to the first embodiment as viewed from an operation unit side.

FIG. 8 is a block diagram illustrating a configuration of a correction system 301 according to a second embodiment.

FIG. 9 is a diagram showing an example of a temperature change of a breakdown voltage V_{BR} of an avalanche photodiode 53 according to the second embodiment.

FIG. 10 is a flowchart showing a method of obtaining an individual parameter executed by the correction system 301 according to the second embodiment.

FIG. 11 is a block diagram illustrating a configuration of a light projecting unit 140 in the optical distance measuring sensor 101 according to a third embodiment.

FIG. 12 is a block diagram illustrating a configuration of the optical distance measuring sensor 101 according to a fourth embodiment.

FIG. 13 is a block diagram illustrating a configuration of a light projecting unit 240 in the optical distance measuring sensor 101 according to the fourth embodiment.

FIG. 14 is a block diagram illustrating a configuration of a light projecting unit 340 in the optical distance measuring sensor 101 according to a fifth embodiment.

### DETAILED DESCRIPTION

Hereinafter, a preferred embodiment of the present disclosure will be described in detail with reference to the drawings. Note that an embodiment described below is merely a specific example for implementing the present disclosure, and is not intended to limit the interpretation of the present disclosure. In addition, in order to facilitate understanding of the description, the same components in the drawings are denoted by the same reference signs as much as possible, and duplicate descriptions may be omitted.

In the drawings, an x-axis, a y-axis, and a z-axis may be illustrated. The x-axis, y-axis, and z-axis form a right-handed three dimensional Cartesian coordinate system. Hereinafter, a direction of an arrow of the x-axis may be referred to as an x-axis + side, and a direction opposite to the arrow may be referred to as an x-axis − side, and the same applies to the other axes. A z-axis + side and a z-axis − side may be referred to as “object side” and “operation unit side”, respectively. The z-axis direction may be referred to as “light beam direction”. Further, planes orthogonal to the x-axis, the Y-axis, or the z-axis may be referred to as a yz plane, a zx plane, or an xy plane, respectively.

### First Embodiment

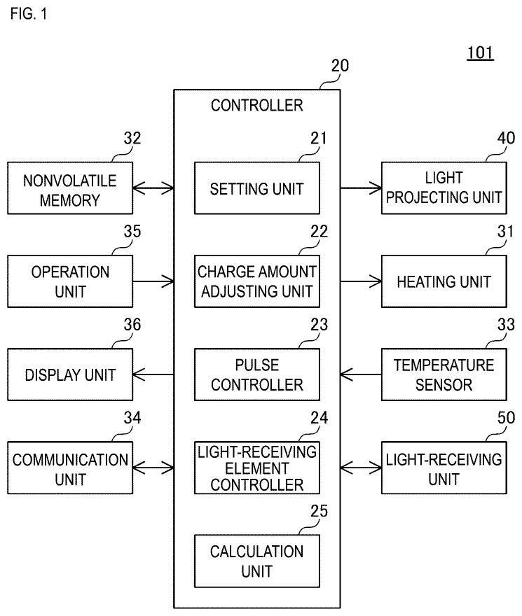

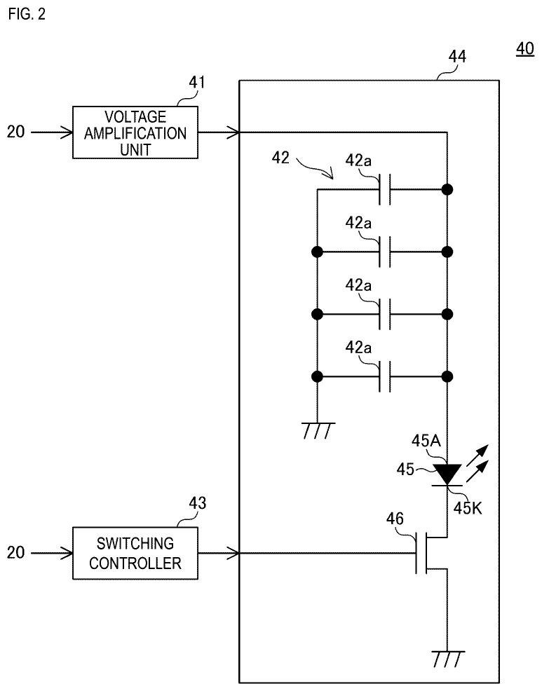

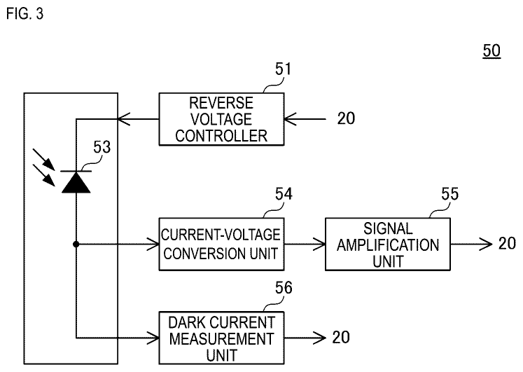

FIG. 1 is a block diagram illustrating a configuration of an optical distance measuring sensor 101 according to a first embodiment. FIG. 2 is a block diagram illustrating a configuration of a light projecting unit 40 in the optical distance measuring sensor 101 according to the first embodiment. FIG. 3 is a block diagram illustrating a configuration of a light-receiving unit 50 in the optical distance measuring sensor 101 according to the first embodiment.

As illustrated in FIGS. 1 to 3, the optical distance measuring sensor 101 includes a controller 20 (an example of “pulse current controller”), a heating unit 31, a nonvolatile memory 32, a temperature sensor 33 (an example of “first temperature sensor” and “second temperature sensor”), a communication unit 34, an operation unit 35, a display unit 36, a light projecting unit 40, and a light-receiving unit 50.

The controller 20 includes a setting unit 21, a charge amount adjusting unit 22 (an example of “voltage controller”), a pulse controller 23, a light-receiving element controller 24, and a calculation unit 25. The controller 20 includes, for example, a central processing unit (CPU) and a field programmable gate array (FPGA).

The light projecting unit 40 includes a voltage amplification unit 41, a switching controller 43, and a pulsed light generating unit 44. The pulsed light generating unit 44 includes a charge accumulation unit 42, a laser diode (LD) 45 (an example of “light-emitting element”), and a transistor 46.

The light-receiving unit 50 includes a reverse voltage controller 51, an avalanche photodiode (APD) 53 (an example of “light-receiving element”), a current-voltage conversion unit 54, a signal amplification unit 55, and a dark current measurement unit 56.

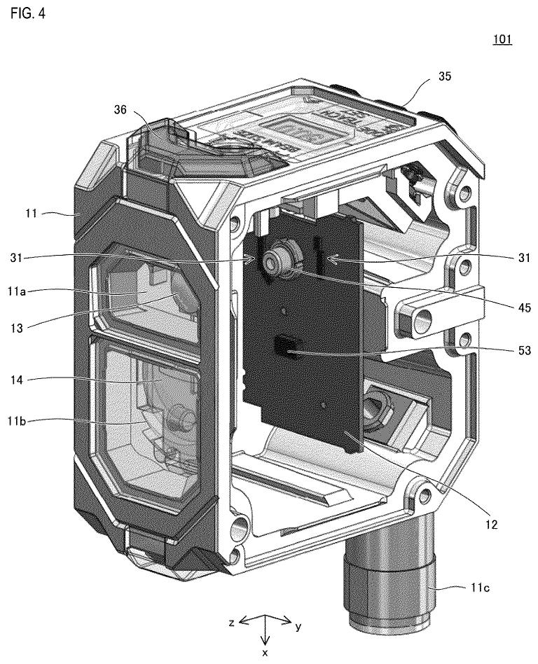

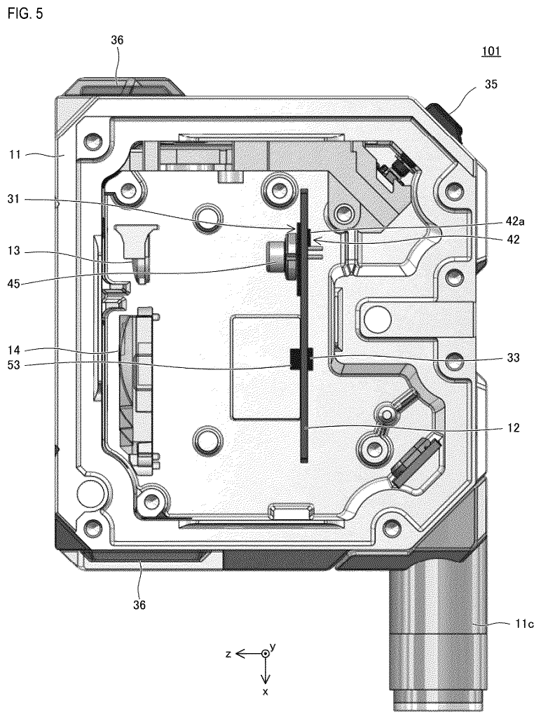

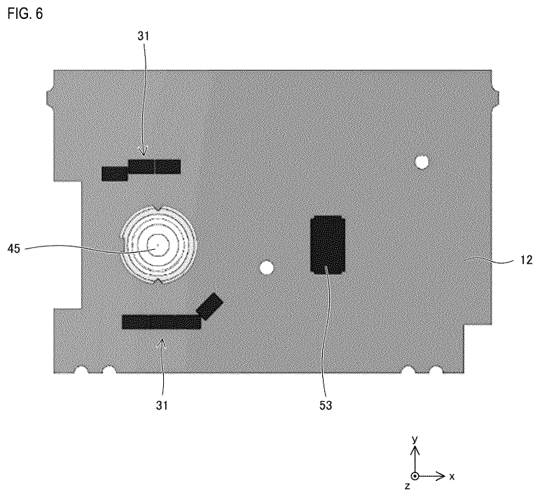

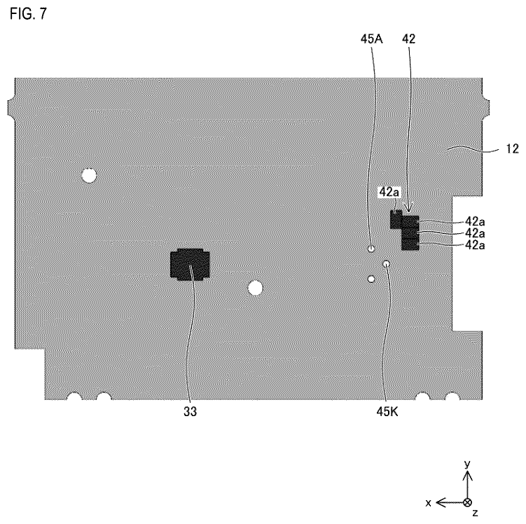

FIG. 4 is a perspective view of the optical distance measuring sensor 101 according to the first embodiment. FIG. 5 is a side view of the optical distance measuring sensor 101 according to the first embodiment. FIG. 6 is a plan view of a sensing substrate 12 according to the first embodiment as viewed from an object side. FIG. 7 is a plan view of the sensing substrate 12 according to the first embodiment as viewed from an operation unit side.

As illustrated in FIGS. 4 to 7, the optical distance measuring sensor 101 further includes a sensor housing 11, a sensing substrate 12, a light projecting lens 13, and a light receiving lens 14. The sensor housing 11 includes a light projecting window 11a, a light receiving window 11b, and a connector 11c.

The sensor housing 11 is a member forming a case of the optical distance measuring sensor 101, and is made of a resin, a metal, or the like. In FIGS. 4 and 5, a side surface of the sensor housing 11 on the y-axis + side is an opening, but the opening can be closed by a lid.

The sensing substrate 12, the light projecting lens 13, and the light receiving lens 14 are provided inside the sensor housing 11. Two openings are formed along the x-axis on a side surface of the sensor housing 11 on the object side. An opening on the x-axis − side and an opening on the x-axis + side are provided with the light projecting window 11a and the light receiving window 11b, respectively.

The sensing substrate 12 has a plate shape extending along a plane parallel to the xy plane. The heating unit 31, the laser diode 45, and the avalanche photodiode 53 are mounted on a substrate surface of the sensing substrate 12 on the object side. The temperature sensor 33 and the charge accumulation unit 42 are mounted on a substrate surface of the sensing substrate 12 on the operation unit side.

The laser diode 45 emits pulsed laser light in a z-axis + direction. The laser light is emitted to an object (not illustrated) located on the object side of the optical distance measuring sensor 101 through the light projecting lens 13 and the light projecting window 11a.

The light receiving lens 14 receives the laser light reflected by the object (hereinafter, may be referred to as reflected light) through the light projecting window 11a and condenses the laser light on the avalanche photodiode 53. A distance from the optical distance measuring sensor 101 to the object is measured based on the time (hereinafter, may be referred to as a propagation time) from the time when the laser light is emitted by the laser diode 45 to the time when the reflected light is received by the avalanche photodiode 53.

As illustrated in FIGS. 1 and 2, the nonvolatile memory 32 is a readable/writable nonvolatile storage device such as an Electrically Erasable Programmable Read-Only Memory (EEPROM), and stores an operation mode table and a program (code). The nonvolatile memory 32 may be another type of nonvolatile storage device such as a flash memory.

The program can be installed from the outside. The program is distributed in a state of being stored in a storage medium readable by the optical distance measuring sensor 101. The program may be distributed on the Internet connected via a communication interface.

The target sensitivity of the optical distance measuring sensor 101 is, for example, a sensitivity for detecting the presence of the object. In the present embodiment, the target sensitivity can be set to, for example, five levels. The target sensitivity may be set to four or less levels or six or more levels.

The target sensitivity is also an index of an operation mode of the optical distance measuring sensor 101. In the operation mode table, each of the setting values of “LD power” and “APD multiplication factor” is associated with the target sensitivity.

The target sensitivity may be set manually or automatically. In a case where the target sensitivity is manually set, one of the five levels of the target sensitivity can be selected by the user. Specifically, for example, when the user performs a predetermined operation for selecting the target sensitivity on the operation unit 35, the target sensitivity of the five levels is displayed on the display unit 36. The user selects the target sensitivity by operating the operation unit 35 while viewing the display unit 36.

The setting unit 21 in the controller 20 sets the target sensitivity of the optical distance measuring sensor 101 based on the operation content of the operation unit 35, and stores target sensitivity information indicating the set target sensitivity in the nonvolatile memory 32.

On the other hand, in a case where the target sensitivity is automatically set, for example, the target sensitivity is set in a procedure in which a projected light spot is applied to each of the object desired to be determined whether presence is detected and a background of the object, and a teaching button included in the operation unit 35 is pressed. The setting unit 21 obtains measurement results when the projected light spot is applied to the object and the background, based on the operation content of the operation unit 35, and sets an optimal target sensitivity that can discriminate the object and the background based on the obtained measurement results. The setting unit 21 stores the set target sensitivity in the nonvolatile memory 32.

The controller 20 causes the charge amount adjusting unit 22 to adjust the pulse current to be supplied to the laser diode 45 based on the target sensitivity. The charge amount adjusting unit 22 adjusts the pulse current based on the target sensitivity. Specifically, the charge amount adjusting unit 22 adjusts the charge amount accumulated by the charge accumulation unit 42 in the light projecting unit 40 based on the target sensitivity information and the operation mode table. In the present embodiment, the charge amount adjusting unit 22 controls the voltage applied to the charge accumulation unit 42 based on the target sensitivity information and the operation mode table.

Specifically, the charge amount adjusting unit 22 recognizes that the LD power corresponding to the target sensitivity indicated by the target sensitivity information is “low” or “high” based on the operation mode table.

The charge amount adjusting unit 22 adjusts the charge amount by controlling the voltage applied to the charge accumulation unit 42. In the present embodiment, the charge amount adjusting unit 22 outputs a pulse wave having the same on time and a different duty ratio according to the operation mode to the light projecting unit 40 at a predetermined cycle. Here, the duty ratio is a value obtained by dividing the on time of the pulse by the predetermined cycle.

Specifically, when the charge amount adjusting unit 22 recognizes that the LD power is “low”, the charge amount adjusting unit 22 outputs a pulse wave of a predetermined duty ratio (hereinafter, may be referred to as a first duty ratio) to the light projecting unit 40.

On the other hand, when the charge amount adjusting unit 22 recognizes that the LD power is “high”, the charge amount adjusting unit 22 outputs a pulse wave of a predetermined duty ratio (hereinafter, may be referred to as a second duty ratio) larger than the first duty ratio to the light projecting unit 40.

The voltage amplification unit 41 (see FIG. 2) in the light projecting unit 40 amplifies the pulse wave received from the controller 20 and outputs the amplified pulse wave to the charge accumulation unit 42.

In the present embodiment, the voltage amplification unit 41 includes a low-pass filter and an operational amplifier. The low-pass filter in the voltage amplification unit 41 smooths the pulse wave received from the controller 20.

Specifically, when receiving the pulse wave of the first duty ratio from the controller 20, the low-pass filter smooths the pulse wave to generate a first DC voltage. Meanwhile, when the low-pass filter receives the pulse wave of the second duty ratio from the controller 20, the low-pass filter smooths the pulse wave to generate a second DC voltage higher than the first DC voltage.

The operational amplifier non-inversely amplifies the first DC voltage or the second DC voltage received from the low-pass filter at a predetermined amplification factor and outputs the amplified voltages to the charge accumulation unit 42.

The charge accumulation unit 42 accumulates charge for generating the pulse current to be supplied to the laser diode 45. In the present embodiment, the charge accumulation unit 42 includes, for example, four capacitor elements 42a connected in parallel to each other. The capacitor element 42a is, for example, a ceramic capacitor. The capacitor element 42a may be another type of capacitor such as a film capacitor or a tantalum electrolytic capacitor. The charge accumulation unit 42 may be configured to include three or less or five or more capacitor elements 42a connected in parallel to each other.

The capacitor element 42a includes one end connected to an output terminal of the operational amplifier of the voltage amplification unit 41 and an anode 45A of the laser diode 45 and the other end connected to the ground. The capacitor element 42a accumulates charge corresponding to the first DC voltage or the second DC voltage each applied from the voltage amplification unit 41.

The pulse controller 23 (see FIG. 1) generates a pulse current in synchronization with a signal that is repeatedly supplied (hereinafter, may be referred to as a repetitive signal), and pulse-drives the laser diode 45. Specifically, the pulse controller 23 causes the charge accumulation unit 42 to discharge the accumulated charge in synchronization with the repetitive signal, and pulse-drives the laser diode 45.

In the present embodiment, the repetitive signal is, for example, a cyclic signal. The cyclic signal is a signal having a cycle of several microseconds, and is generated inside the optical distance measuring sensor 101. The cyclic signal may be generated outside the optical distance measuring sensor 101. Note that the repetitive signal may be a signal that is repeatedly supplied at random timing.

The pulse controller 23 outputs a control signal in synchronization with the cyclic signal to the switching controller 43 in the light projecting unit 40.

The switching controller 43 (see FIG. 2) functions as a driver of the transistor 46. Specifically, the switching controller 43 drives the transistor 46 in the pulsed light generating unit 44 based on the control signal received from the pulse controller 23.

More specifically, when receiving the control signal of a predetermined on-voltage or more from the pulse controller 23, the switching controller 43 outputs a signal for turning on the transistor 46 (hereinafter, may be referred to as an on-signal) to the transistor 46.

Specifically, the switching controller 43 includes, for example, a bipolar transistor. The bipolar transistor includes a collector to which a power supply voltage is applied, a base that receives the control signal from the pulse controller 23, and an emitter connected to the ground through a resistance element.

When the control signal pf the predetermined on-voltage or more is applied to the base, the bipolar transistor transitions from an off state to an on state, and a current flows from the collector to the emitter. The current flows through the resistance element, and thereby the voltage of the emitter increases. The increased voltage of the emitter becomes an on signal that turns on the transistor 46 in the pulsed light generating unit 44.

The transistor 46 is, for example, a field-effect transistor. The transistor 46 includes a drain connected to a cathode 45K of the laser diode 45, a gate connected to the switching controller 43 through a resistance element, and a source connected to the ground through a resistance element.

When the on signal is input from the switching controller 43 to the gate of the transistor 46, the transistor 46 transitions from the off state to the on state, and thus a discharge circuit from one end of the capacitor element 42a in the charge accumulation unit 42 to the other end of the capacitor element 42a through the laser diode 45, the transistor 46, and the ground is closed.

Thus, the charge accumulated in the charge accumulation unit 42 is discharged, a pulsed discharge current flows through the laser diode 45, and the laser diode 45 emits pulsed light.

As illustrated in FIGS. 5 to 7, the charge accumulation unit 42 is disposed near the laser diode 45. In the present embodiment, four capacitor elements 42a in the charge accumulation unit 42 are provided on a surface of the sensing substrate 12 on the operation unit side.

The laser diode 45 is provided on a surface of the sensing substrate 12 on the object side. A terminal of the anode 45A and a terminal of the cathode 45K are provided on a surface on the back side of the surface on the object side, that is, a surface on the operation unit side.

On the surface on the operation unit side, the four capacitor elements 42a in the charge accumulation unit 42 are provided near the terminal of the anode 45A and the terminal of the cathode 45K.

Specifically, a distance between the capacitor element 42a in the charge accumulation unit 42 and the terminal of the anode 45A or the terminal of the cathode 45K is shorter than a distance between the laser diode 45 and the avalanche photodiode 53.

As described above, with the configuration in which the charge accumulation unit 42 is provided near the laser diode 45, it is possible to quickly respond to the transition of the transistor 46 to the on state, and thus it is possible to emit a pulsed laser light (hereinafter, may be referred to as a projected light pulse) having a narrow time width and a large peak intensity from the laser diode 45.

As illustrated in FIGS. 1 and 4 to 7, the heating unit 31 maintains the operable temperature of the laser diode 45 based on the temperature measured by the temperature sensor 33. Specifically, the heating unit 31 controls and maintains the ambient temperature of the laser diode 45 so as to fall within an operable temperature range defined as the specification of the element of the laser diode 45.

In the present embodiment, the heating unit 31 includes seven resistance elements (an example of “first heater” and “second heater”) connected in series to each other, and a switch. Specifically, the seven resistance elements and the switch are connected in series to each other between a power supply voltage supply terminal and the ground.

Three of the seven resistance elements are provided on the y-axis + side of the laser diode 45 on the surface of the sensing substrate 12 on the object side. The other four of the seven resistance elements are provided on the y-axis − side of the laser diode 45 on the surface of the sensing substrate 12 on the object side.

The temperature sensor 33 is provided near the avalanche photodiode 53. In the present embodiment, the avalanche photodiode 53 and the temperature sensor 33 are provided on the surface of the sensing substrate 12 on the object side and on the surface of the sensing substrate 12 on the operation unit side, respectively. When the surface of the sensing substrate 12 on the operation unit side is viewed in plan, the temperature sensor 33 is provided at a position overlapping the avalanche photodiode 53.

In other words, the temperature sensor 33 is provided at a position facing the avalanche photodiode 53 with the sensing substrate 12 interposed therebetween on the surface of the sensing substrate 12 on the operation unit side.

The temperature sensor 33 measures the temperature, for example, at predetermined intervals, and outputs temperature information indicating the measurement results to the controller 20.

The controller 20 monitors the temperature indicated by the temperature information received from the temperature sensor 33, and turns on the switch in the heating unit 31 when the temperature becomes a predetermined value (for example, −10° C.) or lower. Thus, a current flows through the seven resistance elements in the heating unit 31, the seven resistance elements generate heat, and the temperature of the laser diode 45 increases, and thus the ambient temperature of the laser diode 45 is maintained so as to fall within the operable temperature range.

As illustrated in FIG. 3, when the avalanche photodiode 53 in the light-receiving unit 50 is irradiated with light in a reverse bias state, the avalanche photodiode 53 can detect the light with high sensitivity by a self-multiplication effect.

When the reverse bias voltage applied to the avalanche photodiode 53 is increased, the avalanche photodiode 53 can be operated at a high multiplication factor (hereinafter, may be referred to as a gain).

A relationship between the reverse bias voltage and the gain is not linear, and the gain exponentially increases as the reverse bias voltage approaches the breakdown voltage of the avalanche photodiode 53.

In addition, when the avalanche photodiode 53 is used with a high gain, the gain change due to a temperature is large. That is, temperature characteristics of the gain are poor.

The breakdown voltage and the temperature characteristics of the gain of the avalanche photodiode 53 vary for each individual. Thus, it is difficult to operate the avalanche photodiode 53 with a constant high gain in the wide temperature range only by applying a constant reverse bias voltage to the avalanche photodiode 53.

As illustrated in FIGS. 1 and 3, in the present embodiment, the nonvolatile memory 32 stores characteristic data of the individual avalanche photodiode 53.

The characteristic data includes a breakdown voltage V_{BR} of the avalanche photodiode 53, a temperature coefficient γ of the breakdown voltage, and a temperature T_{ref} of the avalanche photodiode 53 when a certain breakdown voltage V_{BR} is obtained. The temperature T_{ref} is a temperature serving as a reference when correction is performed during an operation of the optical distance measuring sensor 101.

In the present embodiment, the breakdown voltage V_{BR} is a reverse bias voltage to be applied in order to cause a dark current of a predetermined value to flow through the avalanche photodiode 53. Specifically, the predetermined value is, for example, 100 microamperes. Details of the temperature coefficient γ will be described below.

A correction expression for providing a reverse bias voltage V_{R} for setting the gain of the avalanche photodiode 53 to G is expressed by, for example, f_{G} (T, V_{BR}, T_{ref}, Y). Here, T is the temperature of the avalanche photodiode 53.

In the operation mode table, the target sensitivity indicated by the target sensitivity information is associated with the APD multiplication factor of “low” or “high”.

In the present embodiment, the nonvolatile memory 32 stores a low-gain correction expression used when the APD multiplication factor is set to “low” and a high-gain correction expression used when the APD multiplication factor is set to “high”.

The low-gain correction expression is expressed by f_{GL} (T, V_{BR}, T_{ref}, γ), and provides a reverse bias voltage V_{R} for setting the gain of the avalanche photodiode 53 to GL.

The high-gain correction expression is expressed by f_{GH} (T, V_{BR}, T_{ref}, γ), and provides a reverse bias voltage V_{R} for setting the gain of the avalanche photodiode 53 to GH larger than GL.

The light-receiving element controller 24 adjusts the gain of the avalanche photodiode 53 based on the temperature T measured by the temperature sensor 33, the characteristic data, and the target sensitivity.

Specifically, the light-receiving element controller 24 calculates the reverse bias voltage V_{R} regularly or irregularly, and causes the reverse voltage controller 51 in the light-receiving unit 50 to generate the reverse bias voltage V_{R}.

Specifically, the light-receiving element controller 24 recognizes that the APD multiplication factor corresponding to the target sensitivity indicated by the target sensitivity information is “low” or “high” based on the operation mode table.

The light-receiving element controller 24 recognizes the temperature T by the temperature information output from the temperature sensor 33.

When the light-receiving element controller 24 recognizes that the APD multiplication factor is “low”, the light-receiving element controller 24 obtains the low-gain correction expression, the breakdown voltage V_{BR}, the temperature T_{ref}, and the temperature coefficient γ from the nonvolatile memory 32, and calculates the reverse bias voltage V_{R} by inputting T, V_{BR}, T_{ref}, and γ to the low-gain correction expression f_{GL} (T, V_{BR}, T_{ref}, γ).

On the other hand, when the light-receiving element controller 24 recognizes that the APD multiplication factor is “high”, the light-receiving element controller 24 obtains the high-gain correction expression, the breakdown voltage V_{BR}, the temperature T_{ref}, and the temperature coefficient γ from the nonvolatile memory 32, and calculates the reverse bias voltage V_{R} by inputting T, V_{BR}, T_{ref}, and γ to the high-gain correction expression f_{GH} (T, V_{BR}, T_{ref}, γ).

The light-receiving element controller 24 controls the reverse voltage controller 51 in the light-receiving unit 50 to generate the calculated reverse bias voltage V_{R}.

The reverse voltage controller 51 includes, for example, a booster circuit. The reverse voltage controller 51 generates the reverse bias voltage V_{R} according to the control by the light-receiving element controller 24, and applies the reverse bias voltage V_{R} to the cathode of the avalanche photodiode 53.

When the avalanche photodiode 53 in a state where the reverse bias voltage V_{R} is applied receives reflected light from the object, a current flows from the cathode to the anode.

The current-voltage conversion unit 54 converts the current flowing through the avalanche photodiode 53 into a voltage and outputs the voltage to the signal amplification unit 55.

In the present embodiment, the current-voltage conversion unit 54 includes, for example, a transimpedance amplifier and a capacitor element. The transimpedance amplifier includes an input terminal connected to the anode of the avalanche photodiode 53 through the capacitor element, and an output terminal connected to the signal amplification unit 55.

An AC component of the current flowing through the avalanche photodiode 53 is input to an input terminal of the transimpedance amplifier. A signal having a voltage corresponding to the current (hereinafter, may be referred to as an output signal) is output from an output terminal of the transimpedance amplifier.

The signal amplification unit 55 amplifies an output signal from the current-voltage conversion unit 54 and outputs the amplified signal to the controller 20.

The calculation unit 25 in the controller 20 calculates the propagation time based on the output signal repeatedly obtained from the avalanche photodiode 53.

In the present embodiment, the calculation unit 25 obtains time-series data based on the output signal received from the light-receiving unit 50, for example, every time the pulse controller 23 outputs the control signal.

Specifically, the calculation unit 25 binarizes the voltage of the output signal based on, for example, the magnitude relationship between the voltage of the output signal and a predetermined threshold value. A start time of the time-series data is, for example, a time at which the control signal is output from the pulse controller 23.

The calculation unit 25 integrates a plurality of pieces of the time-series data and obtains the time-series data integrated (hereinafter, may be referred to as integrated time-series data). The integrated time-series data includes a peak based on the reflected light received by the light-receiving unit 52.

The calculation unit 25 obtains a time at which the avalanche photodiode 53 receives the reflected light (hereinafter, also referred to as a light reception time) by a predetermined detection threshold value.

The calculation unit 25 obtains, for example, a time at which a peak based on the reflected light in the integrated time-series data exceeds the detection threshold value as the light reception time.

The calculation unit 25 estimates a value obtained by multiplying the propagation time from the start time of the time-series data to the light reception time by the speed of light and dividing the product by 2 as the distance to the object.

It is preferable that the pulse current supplied to the laser diode 45 is designed so that the S/N ratio of the output signal obtained from the reflected light is high while the laser diode 45 satisfies the standard of the laser class 1.

The standard of the laser class 1 includes a specification for the average optical power. Specifically, it is specified that the average optical power should not exceed 0.39 mW.

The above specification is expressed by the following Expression (1) where an optical power value, a pulse width, and a pulse cycle of the projected light pulse output from the laser diode 45 are Po (mW), Pw (ns), and T (ns), respectively.

$$Po \times Pw / T < 0.39 mW \qquad ( 1 )$$

In order to increase the S/N ratio, it is necessary to increase Po and decrease Pw, but when the pulse current is generated based on a clock signal, the minimum Pw is half a clock cycle.

In order to achieve high clock frequency while reducing costs, the clock frequency is generally 450 MHz or lower. That is, the minimum Pw is ( 1/450 MHZ)/2≈1.1 ns.

The following Expression (2) is obtained where Expression (1) is modified to Po/T<0.39/Pw (mW/ns) and 1.1 ns is substituted for Pw.

$$Po / T < 0.35 ( mW / ns ) \qquad ( 2 )$$

That is, it is desirable design to determine Po and T so that Po/T is as large as possible while satisfying Expression (2).

Specifically, for example, Pw, Po and T may be 2.7 ns, 500 mw and 4000 ns, respectively.

At this time, Po/T=0.125, and Expression (2) is satisfied. Further, Po×Pw/T=0.34 mW, and Expression (1) is also satisfied.

Similarly, Pw, Po and T may be 1.2 ns, 500 mw, and 2000 ns, respectively.

At this time, Po/T=0.25, and Expression (2) is satisfied. Further, Po×Pw/T=0.30 mW, and Expression (1) is also satisfied.

In a case where Po is made adjustable, T may be designed to be changed in conjunction with Po. For example, in a case where Pw, Po, and T

are set to 2.7 ns, 500 mw, and 4000 ns, respectively, when Po is adjusted to 250 mW, T may be changed to 2000 ns.

With this configuration, the number of times of measurement per unit time can be increased, and thus a noise reduction effect by integration can be expected. Then, the maximum S/N ratio can be exhibited while keeping the standard of the laser class 1.

### Second Embodiment

Next, the optical distance measuring sensor 101 according to a second embodiment will be described. In the second and subsequent embodiments, description of matters common to the first embodiment will be omitted, and only different points will be described. In particular, the same operations and effects by the same components will not be separately mentioned for each embodiment.

The optical distance measuring sensor 101 according to the second embodiment is different from the optical distance measuring sensor 101 according to the first embodiment in that the characteristic data of the avalanche photodiode 53 is obtained by the control of equipment 201.

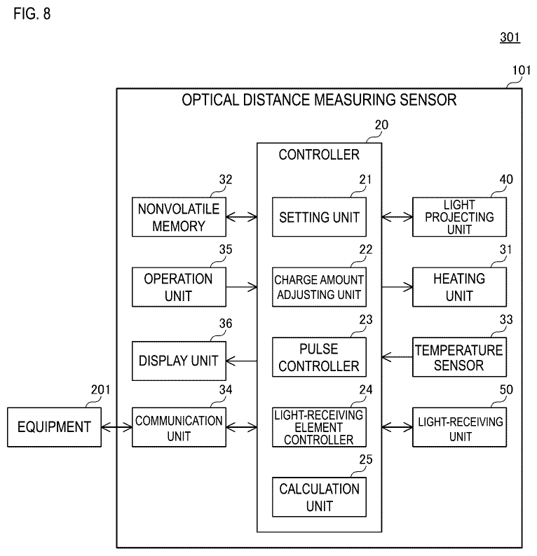

FIG. 8 is a block diagram illustrating a configuration of a correction system 301 according to the second embodiment. As illustrated in FIG. 8, the correction system 301 includes the optical distance measuring sensor 101 and the equipment 201.

The communication unit 34 in the optical distance measuring sensor 101 is, for example, an IO-Link PHY, and is a communication element that communicates with the equipment 201. The equipment 201 and the controller 20 can communicate with each other through the IO-Link PHY 34.

The communication unit 34 is connected to the equipment 201 through a connector 11c in a shipment inspection after product assembly of the optical distance measuring sensor 101, for example. The equipment 201 controls the optical distance measuring sensor 101 through the IO-Link PHY 34.

In the present embodiment, the equipment 201 controls the controller 20 in the optical distance measuring sensor 101 to measure the dark current of the avalanche photodiode 53 while changing the temperature of the avalanche photodiode 53, and obtains the breakdown voltage V_{BR}, the temperature T_{ref}, and the temperature coefficient γ.

The dark current measurement unit 56 in the light-receiving unit 50 measures the dark current of the avalanche photodiode 53. Specifically, the dark current measurement unit 56 measures the dark current when the reverse bias voltage is applied to the avalanche photodiode 53 in a state where no light enters a light receiving surface of the avalanche photodiode 53.

In the present embodiment, the avalanche photodiode 53 is physically covered with a light shielding member at the time of dark current measurement. The dark current measurement unit 56 includes, for example, a resistance element, a low-pass filter, and an operational amplifier.

The resistance element in the dark current measurement unit 56 includes one end connected to the anode of the avalanche photodiode 53 and the other end connected to the ground.

The dark current flowing through the avalanche photodiode 53 flows to the ground through the resistance element. A voltage corresponding to the dark current (hereinafter, may be referred to as a measurement voltage) is generated at one end of the resistance element. Note that a capacitor element may be connected in parallel to the resistance element. Thus, it is possible to stabilize the measurement voltage.

The operational amplifier non-inversely amplifies the measurement voltage received from one end of the resistance element through the low-pass filter at a predetermined amplification factor and outputs the amplified measurement voltage to the controller 20.

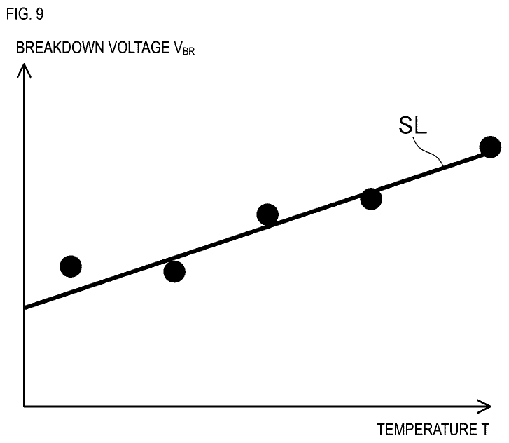

FIG. 9 is a diagram showing an example of a temperature change of a breakdown voltage V_{BR} of the avalanche photodiode 53 according to the second embodiment. The vertical axis represents the breakdown voltage V_{BR}. The horizontal axis represents the temperature T of the avalanche photodiode 53.

As illustrated in FIGS. 3, 6, 8, and 9, the equipment 201 controls the controller 20 to determine the characteristic data based on the dark current value measured by the dark current measurement unit 56 and write the determined characteristic data in the nonvolatile memory 32. The characteristic data is determined based on the dark current values at a plurality of ambient temperatures of the avalanche photodiode 53.

### Method of Obtaining Individual Parameter

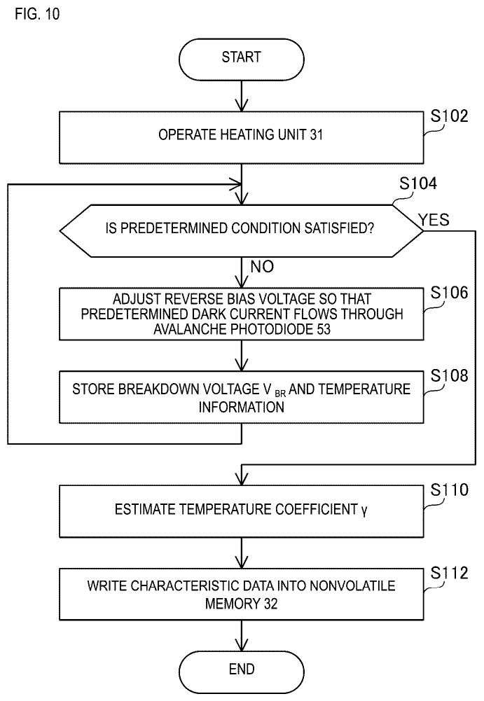

Next, a method of obtaining the individual parameter of the avalanche photodiode 53 in the second embodiment will be described in detail. FIG. 10 is a flowchart showing the method of obtaining an individual parameter executed by the correction system 301 according to the second embodiment. As illustrated in FIG. 10, the method of obtaining the individual parameter includes steps S102 to S112, and each step is executed by the equipment 201 included in the correction system 301.

First, the equipment 201 controls the controller 20 to cause the heating unit 31 to generate heat. The heating unit 31 changes the ambient temperature of the avalanche photodiode 53 (step S102).

Specifically, the heat generated by the heating unit 31 is conducted to the avalanche photodiode 53 through the sensing substrate 12. Thus, the temperature of the avalanche photodiode 53 and the temperature around the avalanche photodiode 53 both increase.

Next, the equipment 201 determines whether a predetermined condition for ending the individual parameter obtaining process is satisfied (step S104). Details of the predetermined condition will be described below.

When the equipment 201 determines that the predetermined condition is not satisfied (NO in step S104), then the equipment 201 controls the controller 20 to adjust the reverse bias voltage applied to the avalanche photodiode 53 while monitoring the measurement voltage from the dark current measurement unit 56 (step S106).

Specifically, the equipment 201 adjusts the reverse bias voltage applied to the avalanche photodiode 53 so that the dark current of the predetermined value flows through the avalanche photodiode 53.

Next, the equipment 201 controls the controller 20 to perform a storage process of storing the reverse bias voltage, that is, the breakdown voltage V_{BR} when the dark current of the predetermined value flows through the avalanche photodiode 53, and the temperature information output from the temperature sensor 33 (step S108).

Next, the equipment 201 determines whether a predetermined condition for ending the individual parameter obtaining process is satisfied (step S104). The predetermined condition is, for example, that the storage process has been performed a predetermined number of times (two or more times) and that the breakdown voltage V_{BR} has been measured in a necessary temperature range.

The storage process is performed a plurality of times while continuing the heating of the avalanche photodiode 53, and thus the breakdown voltages V_{BR} at a plurality of the temperatures T are stored.

When the equipment 201 determines that the predetermined condition is satisfied (YES in step S104), then the equipment 201 estimates the temperature coefficient γ based on the stored breakdown voltages V_{BR} at the plurality of temperatures T (step S110).

Specifically, the breakdown voltage V_{BR} increases as the temperature T increases (see FIG. 9). The breakdown voltage V_{BR} is substantially proportional to the temperature T.

The equipment 201 obtains a straight line SL by approximating a relationship between the temperature T and the breakdown voltage V_{BR} by a linear expression. Then, the equipment 201 estimates a slope of the straight line SL as the temperature coefficient γ.

The equipment 201 controls the controller 20 to write the estimated temperature coefficient γ, the breakdown voltage V_{BR} at the temperature T_{ref}, and the temperature T_{ref} into the nonvolatile memory 32 as the characteristic data of the individual avalanche photodiode 53 (step S112).

### Third Embodiment

Next, the optical distance measuring sensor 101 according to a third embodiment will be described. The optical distance measuring sensor 101 according to the third embodiment is different from the optical distance measuring sensor 101 according to the first embodiment in that the magnitude of the pulse current is adjusted by adjusting an electrostatic capacitance in the charge amount adjusting unit 22.

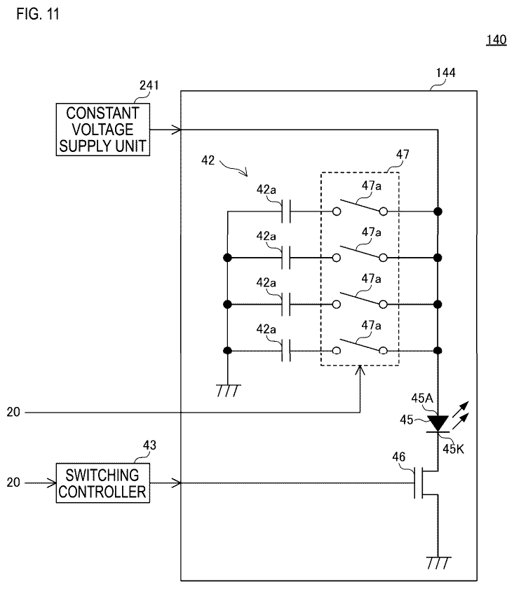

FIG. 11 is a block diagram illustrating a configuration of a light projecting unit 140 in the optical distance measuring sensor 101 according to the third embodiment. As compared with the light projecting unit 40 illustrated in FIG. 2, as illustrated in FIG. 11, the light projecting unit 140 includes a constant voltage supply unit 241 and a pulsed light generating unit 144 instead of the voltage amplification unit 41 and the pulsed light generating unit 44.

As compared with the pulsed light generating unit 44 illustrated in FIG. 2, the pulsed light generating unit 144 further includes a switch unit 47.

As illustrated in FIGS. 1 and 11, the charge amount adjusting unit 22 in the controller 20 adjusts the electrostatic capacitance of the charge accumulation unit 42 based on the target sensitivity information and the operation mode table. The constant voltage supply unit 241 in the light projecting unit 140 supplies a substantially constant voltage from an output terminal.

The switch unit 47 in the pulsed light generating unit 144 includes the same number of switches 47a as the number of the capacitor elements 42a included in the charge accumulation unit 42. In the present embodiment, the switches 47a include four switches 47a.

The four switches 47a are provided corresponding to the four capacitor elements 42a, respectively. Each of the switches 47a includes a first end connected to an output terminal of the constant voltage supply unit 241 and a second end connected to the ground through the corresponding capacitor element 42a.

The switch unit 47 is not limited to a configuration including the same number of switches 47a as the number of capacitor elements 42a included in the charge accumulation unit 42, and may be configured to include a smaller number of switches 47a than the number of capacitor elements 42a. In this case, some of the plurality of capacitor elements 42a are connected to the output of the constant voltage supply unit 241 through the corresponding switches 47a, and the others are directly connected to the output of the constant voltage supply unit 241.

The anode 45A of the laser diode 45 is connected to the output terminal of the constant voltage supply unit 241. The charge amount adjusting unit 22 adjusts the electrostatic capacitance of the charge accumulation unit 42 by controlling the opening and closing of the four switches 47a based on the target sensitivity information and the operation mode table.

In the present embodiment, the charge amount adjusting unit 22 can open and close each of the four switches 47a by outputting a logic signal to the switch unit 47. When the charge amount adjusting unit 22 recognizes that the LD power is “low”, the charge amount adjusting unit 22 closes some of the switches 47a among the four switches 47a and opens the other switches 47a. Hereinafter, the number of switches 47a that are closed when the LD power is “low” may be referred to as a first number.

On the other hand, when the charge amount adjusting unit 22 recognizes that the LD power is “high”, the charge amount adjusting unit 22 closes all of the four switches 47a. Note that, when the charge amount adjusting unit 22 recognizes that the LD power is “high”, the charge amount adjusting unit 22 does not need to close all of the switches 47a as long as the charge amount adjusting unit 22 is configured to close a larger number (hereinafter, may be referred to as a second number) of switches 47a than the first number.

Thus, when the LD power is “low”, the electrostatic capacitance of the charge accumulation unit 42 is the sum of the electrostatic capacitances of the first number of capacitor elements 42a (hereinafter, may be referred to as a first electrostatic capacitance). On the other hand, when the LD power is “high”, the electrostatic capacitance of the charge accumulation unit 42 is the sum of the electrostatic capacitances of the second number of capacitor elements 42a (hereinafter, may be referred to as a second electrostatic capacitance).

When the LD power is “low” or “high”, the charge accumulation unit 42 is charged with charge corresponding to the first electrostatic capacitance or the second electrostatic capacitance, respectively.

Since the second electrostatic capacitance is larger than the first electrostatic capacitance, the magnitude of the pulse current supplied to the laser diode 45 when the LD power is “high” is larger than the magnitude of the pulse current supplied to the laser diode 45 when the LD power is “low”.

### Fourth Embodiment

The optical distance measuring sensor 101 according to a fourth embodiment will be described. The optical distance measuring sensor 101 according to the fourth embodiment is different from the optical distance measuring sensor 101 according to the first embodiment in that the magnitude of the pulse current flowing through the laser diode 45 is adjusted by the voltage applied to the gate of the transistor 46.

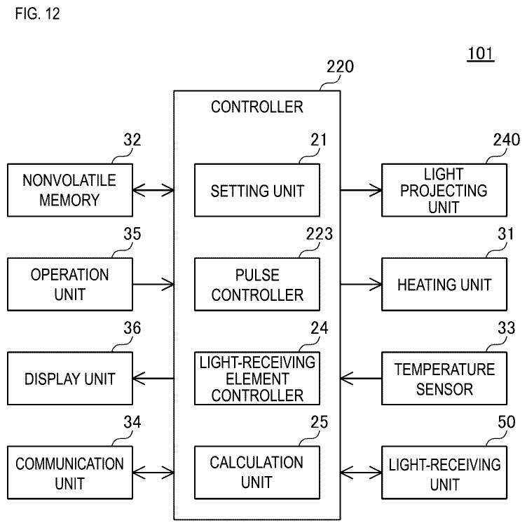

FIG. 12 is a block diagram illustrating a configuration of the optical distance measuring sensor 101 according to the fourth embodiment. As compared with the optical distance measuring sensor 101 illustrated in FIG. 1, as illustrated in FIG. 12, the optical distance measuring sensor 101 according to the fourth embodiment includes a controller 220 and a light projecting unit 240 instead of the controller 20 and the light projecting unit 40. As compared with the controller 20 illustrated in FIG. 1, the controller 220 includes a pulse controller 223 instead of the charge amount adjusting unit 22 and the pulse controller 23.

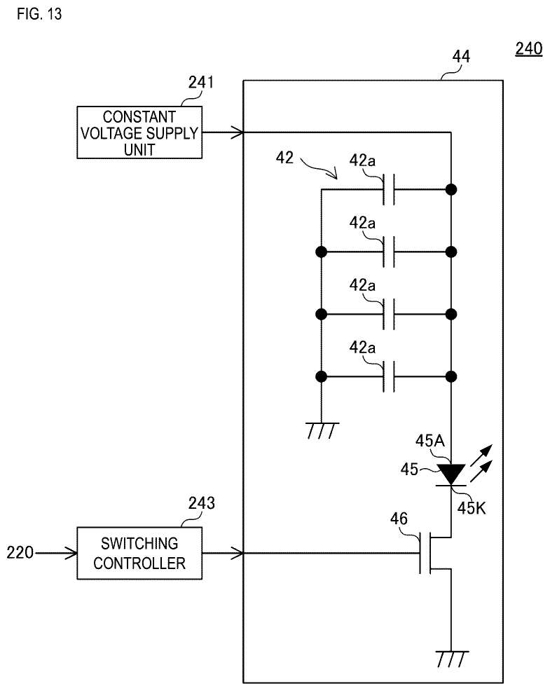

FIG. 13 is a block diagram illustrating a configuration of a light projecting unit 240 in the optical distance measuring sensor 101 according to the fourth embodiment. As compared with the light projecting unit 40 illustrated in FIG. 2, as illustrated in FIG. 13, the light projecting unit 240 includes a constant voltage supply unit 241 and a switching controller 243 instead of the voltage amplification unit 41 and the switching controller 43.

As illustrated in FIGS. 12 and 13, one end and the other end of the capacitor element 42a are connected to the output terminal of the constant voltage supply unit 241 and the ground, respectively.

The switching controller 243 includes, for example, an AC signal source that generates an AC signal. The AC signal source operates under the control of the switching controller 243, and supplies the generated AC signal to the gate of the transistor 46. The generation cycle of the pulse current is adjusted by adjusting the cycle of the AC signal. The magnitude of the pulse current is adjusted by adjusting the magnitude of the amplitude of the AC signal.

The pulse controller 223 generates a pulse current in synchronization with the repetitive signal, pulse-drives the laser diode 45, and adjusts the pulse current based on the target sensitivity.

In the present embodiment, the pulse controller 223 adjusts the magnitude of the pulse current flowing between the drain and the source of the transistor 46 by controlling the switching controller 243 based on the target sensitivity information and the operation mode table.

Specifically, the pulse controller 223 recognizes that the LD power corresponding to the target sensitivity indicated by the target sensitivity information is “low” or “high” based on the operation mode table.

When the pulse controller 223 recognizes that the LD power is “low”, the pulse controller 223 controls the switching controller 243 to set the amplitude of the AC signal supplied to the gate of the transistor 46 to a first value.

On the other hand, when the pulse controller 223 recognizes that the LD power is “high”, the pulse controller 223 controls the switching controller 243 to set the amplitude of the AC signal supplied to the gate of the transistor 46 to a second value larger than the first value.

The pulse controller 223 adjusts the cycle of the AC signal supplied to the gate of the transistor 46 so as to be in synchronization with the cyclic signal generated inside the optical distance measuring sensor 101, for example.

Thus, it is possible to make the magnitude of the pulse current flowing through the laser diode 45 when the LD power is “high” larger than the magnitude of the pulse current flowing through the laser diode 45 when the LD power is “low”.

### Fifth Embodiment

The optical distance measuring sensor 101 according to a fifth embodiment will be described. The optical distance measuring sensor 101 according to the fifth embodiment is different from the optical distance measuring sensor 101 according to the fourth embodiment in that a current mirror circuit is used to adjust the magnitude of the pulse current flowing through the laser diode 45.

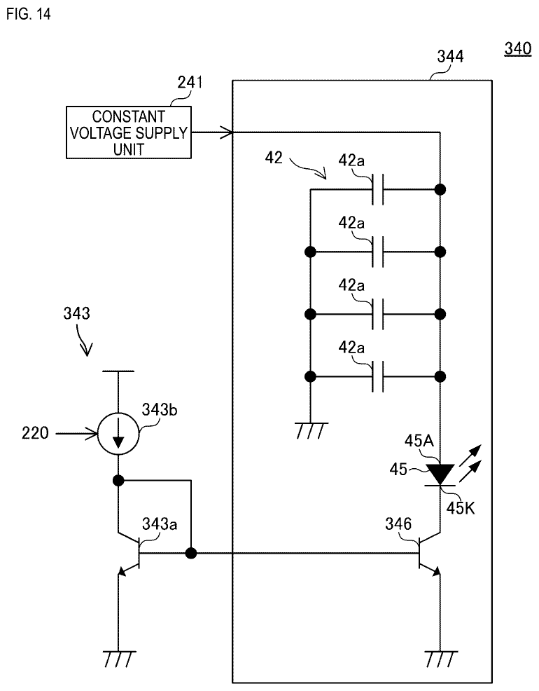

FIG. 14 is a block diagram illustrating a configuration of a light projecting unit 340 in the optical distance measuring sensor 101 according to the fifth embodiment. As compared with the light projecting unit 240 illustrated in FIG. 13, as illustrated in FIG. 14, the light projecting unit 340 includes a pulsed light generating unit 344 and a switching controller 343 instead of the pulsed light generating unit 44 and the switching controller 243.

As compared with the pulsed light generating unit 44 illustrated in FIG. 13, the pulsed light generating unit 344 includes a transistor 346 instead of the transistor 46. The switching controller 343 includes a transistor 343a and a constant current source 343b.

The transistor 343a and the transistor 346 are NPN bipolar transistors. A collector, a base, and an emitter of the transistor 346 are connected to the cathode 45K of the laser diode 45, a base of the transistor 343a, and the ground, respectively.

The transistor 343a is diode-connected, and includes a collector and a base connected to the constant current source 343b, and an emitter connected to the ground.

Since a voltage between the base and the emitter of the transistor 346 is substantially equal to a voltage between the base and the emitter of the transistor 343a, a current (hereinafter, may be referred to as an output current) flowing between the collector and the emitter of the transistor 346 is substantially equal to a current (hereinafter, may be referred to as a reference current) flowing between the collector and the emitter of the transistor 343a.

As illustrated in FIGS. 12 and 14, in the present embodiment, the pulse controller 223 adjusts the pulse current flowing between the collector and the emitter of the transistor 346 by controlling the constant current source 343b based on the target sensitivity information and the operation mode table.

Specifically, the pulse controller 223 recognizes that the LD power corresponding to the target sensitivity indicated by the target sensitivity information is “low” or “high” based on the operation mode table.

When the pulse controller 223 recognizes that the LD power is “low”, the pulse controller 223 controls the constant current source 343b to set the magnitude of the reference current to the first value.

On the other hand, when the pulse controller 223 recognizes that the LD power is “high”, the pulse controller 223 controls the switching controller 243 to set the magnitude of the reference current to the second value larger than the first value.

The pulse controller 223 causes the constant current source 343b to output a pulsed reference current in synchronization with a cyclic signal generated inside the optical distance measuring sensor 101, for example.

Thus, it is possible to make the magnitude of the pulse current flowing through the laser diode 45 when the LD power is “high” larger than the magnitude of the pulse current flowing through the laser diode 45 when the LD power is “low”.

In the first to fifth embodiments, the configuration has been described in which the laser diode 45 is used as the light-emitting element, but the present disclosure is not limited thereto. The configuration may be such that for example, a light-emitting diode is used as the light-emitting element.

In the first to fifth embodiments, the configuration has been described in which the avalanche photodiode 53 is used as the light-receiving element, but the present embodiment is not limited thereto. Other types of light-receiving elements may be used as long as the light-receiving elements have a self-amplifying function.

In the first embodiment and the third to fifth embodiments, the configuration has been described in which the optical distance measuring sensor 101 includes the communication unit 34 and the dark current measurement unit 56, but the present embodiment is not limited thereto. The optical distance measuring sensor 101 may be configured not to include at least one of the communication unit 34 and the dark current measurement unit 56. Even with such a configuration, the object of the present disclosure can be achieved.

In the first to fifth embodiments, the configuration has been described in which the temperature sensor 33 serves three purposes, i.e., the purpose of adjusting the multiplication factor of the avalanche photodiode 53, the purpose of determining the characteristic data, and the purpose of maintaining the operable temperature of the laser diode 45, but the present embodiment is not limited thereto. The configuration may be such that the optical distance measuring sensor 101 further includes another temperature sensor (an example of “second temperature sensor”), and the other temperature sensor serves the purpose of determining the characteristic data or the purpose of maintaining the operable temperature of the laser diode 45.

In the first to fifth embodiments, the configuration has been described in which the heating unit 31 serves two purposes, i.e., the purpose of maintaining the operable temperature of the laser diode 45 and the purpose of changing the ambient temperature of the avalanche photodiode 53, but the present embodiment is not limited thereto. The configuration may be such that the optical distance measuring sensor 101 further includes another heating unit (an example of “second heater”), and the heating unit 31 (an example of “first heater”) and the another heating unit serve the purpose of maintaining the operable temperature of the laser diode 45 and the purpose of changing the ambient temperature of the avalanche photodiode 53, respectively.

The above-described embodiment is provided for facilitating understanding of the present disclosure, and is not intended to limit the interpretation of the present disclosure. Each element included in the embodiment as well as the arrangement, material, condition, shape, size, and the like of each element are not limited to those exemplified and may be changed appropriately. Further, the configurations described in different embodiments can be partially replaced or combined.

### Supplementary Note 1

Disclosed herein is an optical distance measuring sensor (101) for estimating a distance to an object by measuring a time from when light is emitted to the object to when reflected light is received, the sensor including:
a charge accumulation unit (42) configured to accumulate charge for generating a pulse current to be supplied to a light-emitting element (45);
a setting unit (21) configured to set a target sensitivity of the optical distance measuring sensor;
a pulse current controller (20) configured to generate the pulse current in synchronization with a repetitive signal, and to pulse-drive the light-emitting element, the pulse current controller (20) being configured to adjust the pulse current based on the target sensitivity;
a light-receiving element (53) configured to receive the reflected light;
a first temperature sensor (33);
a nonvolatile memory (32) having characteristic data of the individual light-receiving element stored therein;
a light-receiving element controller (24) configured to adjust a multiplication factor of the light-receiving element based on a temperature measured by the first temperature sensor, the characteristic data, and the target sensitivity; and
a calculation unit (25) configured to calculate the time based on an output signal repeatedly obtained from the light-receiving element in which the multiplication factor has been adjusted.

1. An optical distance measuring sensor for estimating a distance to an object by measuring a time from when light is emitted to the object to when reflected light is received, the sensor comprising:
a charge accumulation unit configured to accumulate charge for generating a pulse current to be supplied to a light-emitting element;
a setting unit configured to set a target sensitivity of the optical distance measuring sensor;
a pulse current controller configured to generate the pulse current in synchronization with a repetitive signal, and to pulse-drive the light-emitting element, the pulse current controller being configured to adjust the pulse current based on the target sensitivity;
a light-receiving element configured to receive the reflected light;
a first temperature sensor;
a nonvolatile memory having characteristic data of the individual light-receiving element stored therein;
a light-receiving element controller configured to adjust a multiplication factor of the light-receiving element based on a temperature measured by the first temperature sensor, the characteristic data, and the target sensitivity; and
a calculation unit configured to calculate the time based on an output signal repeatedly obtained from the light-receiving element in which the multiplication factor has been adjusted.

2. The optical distance measuring sensor according to claim 1, wherein the pulse current controller adjusts the pulse current by adjusting a charge amount accumulated by the charge accumulation unit based on the target sensitivity.

3. The optical distance measuring sensor according to claim 2, wherein the pulse current controller adjusts the charge amount by controlling a voltage applied to the charge accumulation unit.

4. The optical distance measuring sensor according to claim 1, further comprising:
a second temperature sensor; and
a heater configured to maintain an operable temperature of the light-emitting element based on a temperature measured by the second temperature sensor.

5. The optical distance measuring sensor according to claim 4, wherein the heater, the first temperature sensor, the light-emitting element, and the light-receiving element are mounted on the same substrate.

6. The optical distance measuring sensor according to claim 4, wherein the first temperature sensor and the second temperature sensor are combined.

7. The optical distance measuring sensor according to claim 1, wherein the characteristic data includes a breakdown voltage of the light-receiving element, a temperature coefficient of the breakdown voltage, and a temperature at a time of obtaining the breakdown voltage.

8. The optical distance measuring sensor according to claim 1, wherein the light-emitting element is a laser diode.
